(19) United States
(12) Patent Application Publication
(10) Pub. No.: US 2025/0036708 A1
(43) Pub. Date: Jan. 30, 2025

(54) Legacy App

(71) Applicant: DeQuarius Antezz King, Dolemite, AL (US)

(72) Inventor: DeQuarius Antezz King, Dolemite, AL (US)

(21) Appl. No.: 18/360,088

(22) Filed: Jul. 27, 2023

(51) Int. Cl. G06F 16/958; G06F 16/955; H04L 67/306; H04W 4/024

(52) U.S. Cl. CPC G06F 16/958; G06F 16/44; G06F 16/9554; H04W 4/024

(57) ABSTRACT

The Legacy App comprises a digital mobile application platform consisting of interfaces to systems and methods to access profiles of deceased/interred individuals created by authorized account holders. The app will serve as a process manager for sharing burial site locator link, uploading photographs, videos, journal reels, and .pdf versions of obituaries to a memorial profile. These profiles will be made available and accessible at the burial site for those seeking ancestral data, general information, performing research, or just accessing while visiting the site. The app is configured in Legacy Accounts and Administrative Accounts to manage and curate the uploaded data and to manage the access and dissemination by users. The Legacy Plate™ will facilitate the physical digital access and GPS precise location of the memorials through QR code scanning technology at the site. The GPS manager interface will utilize Trimble DA2 Catalyst Precision SDK and Global Navigation Satellite Technology.

### FIELD OF THE INVENTION

The present invention relates to mobile application accounts for smart devices for the management and dissemination of digital memorial data for deceased and/or interred individuals. More particularly, the invention relates to a digital platform that provides the account holders the capacity to build and manage everlasting digital representations of obituaries, pictures, videos, music, or journals as memorials for their deceased loved ones that can be accessed from QR code scanning technology at gravesites and other memorial sites. Additionally, the platform will provide GPS location services for these Legacy App outfitted burial sites.

### BACKGROUND

Although, laying a family member to rest is an experience common to everyone, and it is a topic that is rarely discussed beyond the death and burial of a loved one. The mental stress that comes with burying a deceased loved one can be unbearable. The memories of a loved one should be cherished and preserved. When possible, accurate information and memories of a deceased loved one should be accessible for family and ancestral consumption in perpetuity.

Technological advances in smart devices have made it possible for almost anyone to capture and save memorable moments of others and even themselves whether stills or videos. Digital representations and voice recordings of individuals speaking, singing, or just sharing information is being amassed. At the same time, technology has facilitated the embedding of those voice recordings, pictures and videos into written text and other display mediums. Additionally, those technological advances have made those capabilities readily and easily accessible, and operationally simple for just about anyone who has a smart device or computer. Consequently, this generation can store a sizeable amount of data over the course of the life of their loved ones.

Often times during the death and burial of an individual, circumstances prevent some relatives and friends from attending memorial services in person. Some relatives and friends just don't receive news of the death until memorial services are well past. For those individuals to obtain information about the death and burial, technology has created all sorts of mediums for them to receive copies of obituaries, pictures, video recorded services, and virtual services. Such access, however, is dependent on someone emailing, faxing, texting, or commercially mailing the items. In most cases, the home going service will be the last time relatives and friends would see the individual.

While receiving the information is possible, the content received by those individuals is limited in many aspects. The recipient receives pieces of information that makes a limited statement about a point in time regarding the deceased and family members. The new digital era makes it possible to increase the engagement and perpetuate the essence of loved ones for eternity.

Traditionally, photo albums and folk tales were the source for telling the story of deceased loved ones. The present invention brings perpetual digital photo albums and biodata to the gravesite for all visitors and researchers. Additionally, the data can be updated as desired by the family of the deceased loved one.

An example of a digital legacy and location services for burial sites using systems and methods can be seen in U.S. patent Ser. No. 10/015,628 filed on Jan. 9, 2018 by Georgiy L. Khayet et al., which describes a mobile app installed on a mobile device matching a user associated with the mobile app to the burial site, receiving location data from the mobile device, determining that the mobile device is within a predetermined geofence associated with a location of the burial site.

Therefore a need exists for a novel digital platform which incorporates methods and systems to provide capability for families to upload photographs, videos, journal reels, obituaries, etc., of their deceased loved ones to serve an everlasting memorial which can be accessed at the gravesite on smart devices or on a computer. There is also a need for the precise location and geospatial preservation of burial sites. Cemetery representatives spend countless hours searching for individual burial plots with outdated maps and markers. The precise location of each Legacy Plate will be uploaded to Legacy Site Map with the use of Trimble Precision technology. The present invention offers a system that allows for driving and walking directions to the precise location of these Legacy Sites.

The use of QR codes in restaurant ordering systems and methods can be seen in U.S. Pat. No. 325,508 published on Oct. 24, 2019, by Michael Kaye. A system that offers graphical representations of restaurant ordering selections using QR code and scanning technology. Repeated use QR code scanning technology enhances in-person and electronic ordering experiences by simplifying the collection and delivery of the order. Legacy App incorporates QR code scanning technology to streamline biodata and mobile application engagement.

### BRIEF SUMMARY OF THE INVENTION

Legacy App provides a digital platform incorporating methods and systems to facilitate family control of digital information regarding lineage and gravesite experience of researchers or visitors to the graves of their deceased loved ones. Legacy App will serve as a process manager for uploading photographs, videos, journal reels, and .pdf versions of obituaries to a story reel for consumption in the way that platforms like Instagram and Snapchat function. The digital memorials will upload to a public explore feed as well as QR coded customized Legay Plates that will be displayed on foot-markers by adhesive. These Plates will be acquired through the Legacy App and will be installed at the burial site location by trained Legacy App Technicians. The customized site markers, headstones, and Urns are equipped with QR codes linked to perpetual profiles of deceased individuals on the Legacy App Platform. The Legacy Plate will have GPS tracking feature to serve as site locator for gravesites and memorial sites for generations to come. Once at the site, the scanning of the QR code will allow the user to view the digital memorial created and managed by authorized account holders. The Legacy App will also function as a family tree of historical and ancestral information that can be member managed and curated. The Legacy App will serve as the foundation for families to build family databases of everlasting memories and accurate family trees for future generations. The Legacy App platform will store information that will always have useful purposes in current or future technologies and research of family history.

### BRIEF DESCRIPTION OF THE DRAWINGS

FIG. 1—FIG. 1 depicts Standard Legacy Plate Design with name and dates added.

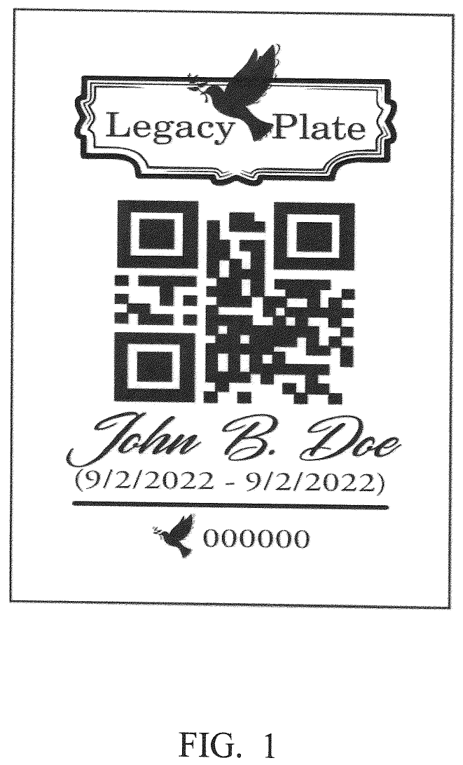

FIG. 2—FIG. 2 depicts Legacy Plate Design without name and address.

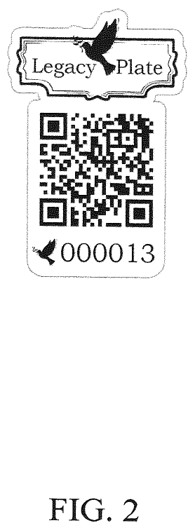

FIG. 3—FIG. 3 depicts the Legacy App Logo which can be depicted on PC, IOS, and Android operating systems.

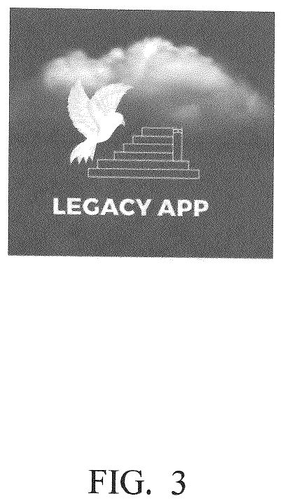

FIG. 4—FIG. 4 depicts a profile view of the Standard Legacy Plate Stand.

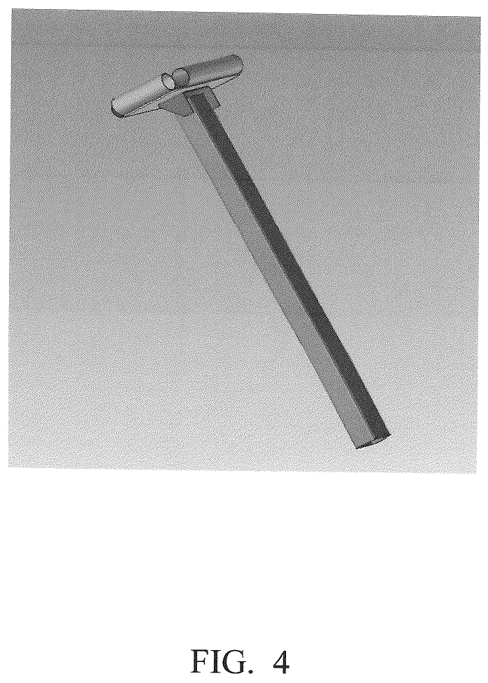

FIG. 5—FIG. 5 depicts a top view of the Standard Legacy Plate Stand.

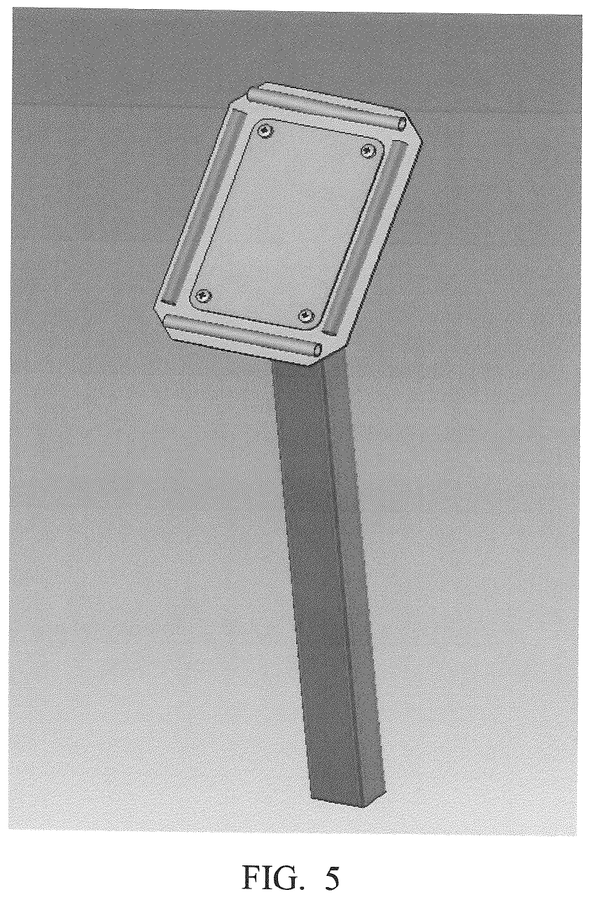

FIG. 6—FIG. 6 depicts a front view of the Standard Legacy Plate Stand.

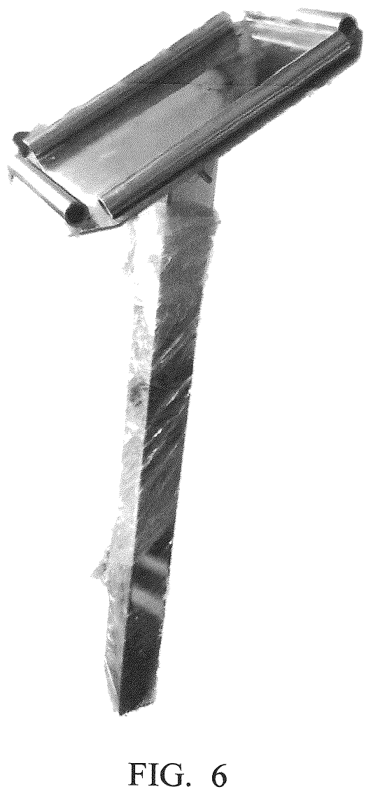

FIG. 7—FIG. 7 depicts the Legacy Head Stone Design without picture.

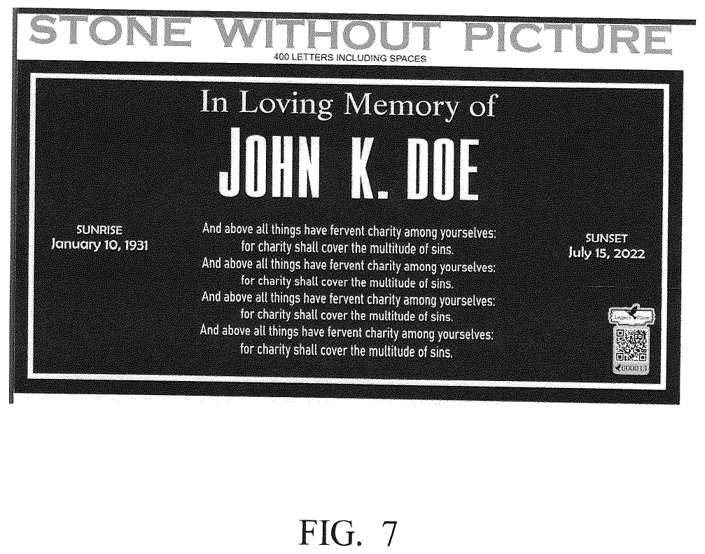

FIG. 8—FIG. 8 depicts the Legacy Head Stone Design, including picture.

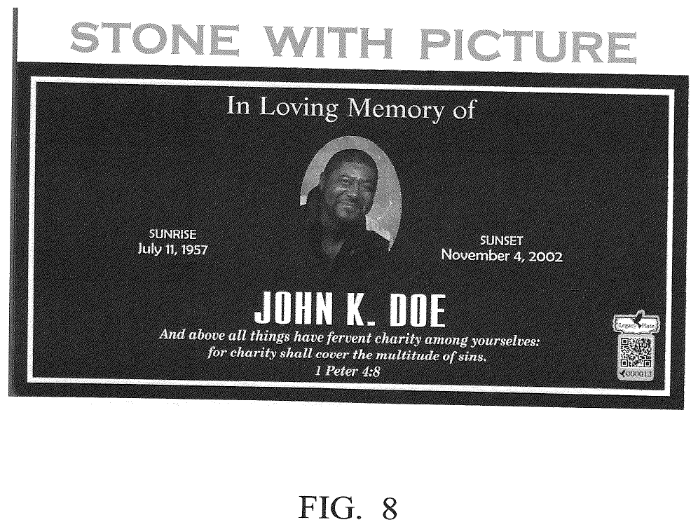

FIG. 9—FIG. 9 depicts Signature Legacy Plate Dove.

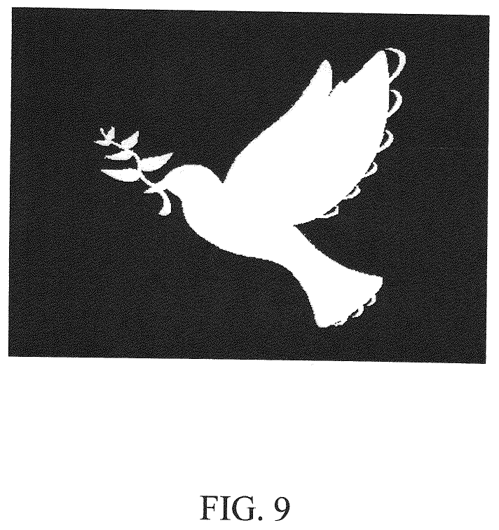

### DETAILED DESCRIPTION OF THE INVENTION

The Legacy App allows families to take more control of their lineage, assets, and grave site experiences moving into this digital era. The app will serve as a simple uploading application for pictures, videos, journal reels, and pdf versions of obituaries to profile for deceased loved ones like Facebook. In-App purchases of Legacy Plates will allow users to customize plates and upload digital memorials of deceased loved ones. The custom Legacy Plate designs are equipped with QR codes linked to the Legacy App platform. The link will be directed to the Digi Legacy mobile app with access to biodata and highlights to commemorate loved ones.

The GPS tracking feature on the custom plate designs will serve as everlasting site locator for gravesites and memorials. Locating legacy sites with a simple link share or entry of dove number can become very convenient to users. Upon arriving at the site and scanning the QR code, the user will be able to view the digital memorial created by the authorized account holders and other information and engagements. Additionally, software updates will continue to innovate the platform for family tree-oriented death records and management of digital memorials and assets. The Legacy App Unity profiles will be member managed spaces geared towards building digital representation of loved ones and everlasting digital memorials while creating unity within the family through estate planning and asset management. The Legacy Accounts will have an estate planning feature that gives estate planning tips from licensed professionals. The key is to create a space for the storage of everlasting memories while simplifying approaches to build generational wealth. Extending this digital representation device to grave sites that are linked to user profiles will enhance gravesite experiences and engagements. Furthermore, the QR codes will eventually be linked to cause of death records, family tree database, and digital asset allocator.

Consumer Accounts: Consumer interfaces are simple and easy to use. Consumers accounts are for the facilitation of in-app purchases, Legacy Site locator, as well as digital memorial management. Users will be able to sign up manually or by connecting through Facebook, Google, or other media accounts.

Administrative Accounts: The administrative accounts will be geared towards funeral home and cemetery representatives. The representative will create a profile with general business and tax information. Managing orders, Legacy Plate™ inventory listing, special key assignment, workflow charts, and fulfillment will be all accessible to representative accounts. There will also be super admin accounts for only official legacy app personnel.

Employee Accounts: Trained Legacy App Technicians will be equipped with Trimble Catalyst DA2 GNSS receivers to achieve nearly 1 cm precision accuracy to add locations to a national bass map of Legacy Sites. Technicians will also be trained on the entirely customized Trimble precision integrated software that streamlines communication with Trimble made GNSS sensors. This Legacy App software was entirely customized to achieve within 1 cm precision accuracy of each activated Legacy Plate.

### Functions of Installation App:

1. Total cemetery land survey and detailed map creation.
2. Manage the input of precise location for individual Legacy outfitted plots in association with dove numbers once they are installed.
3. Manage total workflow, work orders, and land survey for Legacy App technicians.

Explore Feed: The explore feed will be a series of public memorials that are created by authorized user of the deceased, sustained by gratitude and acknowledgments from friends and family. Family and friends will be able to engage posts in the form of love, respect and signature accumulations. The signature page will be to acknowledge who has visited the digital memorial. Posts are managed by the authorized users with Legacy key.
Public Explore Feed Dashboard
(Public Feed of Digital Memorials from guest and unity accounts)
   Feed of Pictures, Videos, Journal Posts to public and private story reels, PDF Obituary posted by unity and guest accounts.
   Love, Respect, Signature Pae allowed on public posts. (Based on privacy settings managed upon upload from account holder).

Legacy Plates Installation/Trimble Mobile Manager App: The ability to digitize death data at the burial site with perpetual pinpointed locations is granted with this present invention. In-app purchase of Legacy Plates, equipped with QR code scanning and GPS precision location technology preserves burial sites for another 200 years. What we have is a mobile app that allows users to manage digital memorials and GPS site locator. In addition to the mobile app, we offer custom gravesite markers, with QR codes that allows visitors to view pictures, videos, and obituaries at the grave site. GPS site locator directions are achieved through the employee installation interface with connection to high accuracy Trimble DA2 catalyst receivers. With s subscription-based account, users will be able to search individual plots by name, link share, or dove number. Trained Legacy App Technicians will be equipped with Trimble Catalyst DA2 GNSS receivers to achieve 1-10 cm precision accuracy to add locations to a national base map of Legacy Sites. Technicians will be trained on the entirely customized Trimble SDK precision integrated app that streamlines communication with Trimble GNSS receiver. This Legacy App software was entirely customized to achieve 1-10 cm precision accuracy of each activated Legacy Plate with the DA2 Catalyst. Information on the device can be found below. The Trimble Mobile Manager app was developed with the integration of Trimble TPSDK software. Trimble developer license agreement terms applied.

Future and Sustainability: The future of the Legacy App LLC is centered around digital estate planning. With the Metaverse and the prevalence of NFTs, digital currencies fast approaching, the Legacy App will give consumers the ability to store and manage digital assets in preparation for generational preservation. Legacy Accounts will be the interface for account holders looking to connect with other family members, upload everlasting memories for Legacy Plate, post in the explore feed, *** Create/Upload Animated Self Portrait for NFT rewards program, financial estate planning advice and asset allocator. Subscriptions are required for the NFT rewards and estate planning account feature. The utility of Legacy App NFT are subscription-based incentives that accumulate payouts for beneficiaries over time. Similar to Self-lender app, the user will make monthly payment that is eligible for payouts to beneficiaries upon the death and installation of Legacy Plate of the account holder. Single and Member managed accounts will allow members to plan family events and trips, Customize Legacy Plates, authorize beneficiary of social media and Legacy Plate™ uploads, purchase single and group estate planning subscriptions. Every user will create a profile and enter the web of family tree-oriented connections, Like LinkedIn business application. Eventually, consumers will be able to collect inheritance of simple digital asset trust, deeds for real-estate trust, and will specifics with a simple scan of a Legacy Plate™ at the burial site. Legacy account holders will have the power to set up their estate planning affairs (will, simple irrevocable trusts, and real irrevocable trusts, power of attorney) with the guidance of “Legacy App Tips from Experts” feature. The simple estate planning feature of Legacy Accounts will be easy to manage by linking mobile banking apps and cryptocurrency wallets while legal submissions will be notarized and filed with the respective officials. Software updates will include new products and services. For example, services such as Flower Delivery and Setup for holidays and birthdays. This feature will be added, and infrastructural personnel will follow. Legacy app technicians, trained on Trimble devices for installation will incorporate the flower service to their workflow.

*Subscription based estate planning packages.
Estate Planning Packages Dashboard (In-App Purchase)*
   Individual/Family Packages (Payment processing)
   Assessment for individual or family financial goals and investment interests
   Financial Announcement/News Feed based on Interests and goals assessments
   Daily, weekly, or monthly Notifications
   NFT Rewards program

Individual/Family Estate Planning Management Packages includes: (In-App Purchase).
Life Insurance Strategies for the Young and Old
REITs
Heir Property
Wills, Trusts, and power of Attorney Declaration
Family & Personal Finance

Birthday/Holiday Flower Subscription: (In-App Purchases)
Delivery and set up of flowers and balloons on birthdays and holidays of your choice at Legacy Sites.

### Finalized Workflow for Beta Version of App

3 KINDS OF USERS
Super admin for king
   Add/Edit/delete Funeral home manager.
   See Orders for each funeral home
   Order from Funeral
   Deliver order to Funeral
   Reported Keys from customer/complains
   Add Design of legacy plates (Price, Image, description)
   Setting=>Delivery Fee, Tax Fee, Shipping Fee, Installation Fee
Funeral Home admin panel
   Orders
   Pass order to admin
   Get Order status from admin
   Receive legacy plate of customer
   Apply to name plate: Barcode plate
   Notify customers and send a special key connect with that person and store in inventory of database.
   Reported Keys from customer/complains
Mobile app for customer
   Login (Guest Login too)
   Signup (Apple, Google, fb. OTP)
   See different design of legacy Plates
   Legacy plate detail page
   Customize legacy plate
      Add GPS (Extra Pay)
      Color Selections
      Special Message
   Order payment
   My orders
      Status updates from admins
      Report Order
      Send Messages
      Modify order
      Get Delivery documents (Key, Information from funeral home)=
      Upload Documents videos photos using that special key

### Explore Feed

Explore Feeds (Post Image/Video/text/PDF Documents)
   Public/Private feed and only special key person can post this
   Others can see only this feed if it is public
   If it is private then you need to scan legacy plate
   Love/Respect and Add signature post

1. A digital mobile application platform process providing access to certain permanently stored GPS coordinates and digital memorial profiles of certain deceased/interred individuals, the method comprising:
receiving private account holder identifying information from a smart device or computer;
matching and authorizing, based on the account holder identifying information, providing capability for account holder to upload and control input of photographs, videos, journal reels, obituaries, etc., of certain deceased/interred individuals to establish certain memorial profiles;
integrating Trimble Precision GNSS, Google Maps, and digital memorial profiles;
receiving GPS tracking features from QR coded customized scanning technology;
matching and linking, based on Legacy Plate installs, GPS coordinates of burial or other memorial sites;
receiving public user identifying information from a mobile application installed on a mobile device to access GPS coordinates and upload to Google Maps;
matching and authorizing, based on the user identifying information, a user associated with the mobile application to access memorial profiles of certain deceased/interred individuals;
receiving location data from the mobile device;
based on location data, determining that the mobile device is within a predetermined geofence associated with a location of the burial site or other memorial sites;
based on the determination, providing the user, via the mobile application, with guidance to the location of the burial or other memorial site; and
automatically receiving, via mobile application, a digital memorial profile of the deceased/interred person associated with a certain burial or other memorial site upon determination that the mobile device is within the predetermined geofence associated with the location of the site.

2. The method of claim 1, further comprising:
receiving from the user, via mobile application, a request for directions to the location of the burial or other memorial site while located outside the geofence; Providing the user, via the mobile application, the directions to the burial or other memorial site.
